(19) United States
(12) Patent Application Publication
(10) Pub. No.: US 2026/0278356 A1
(43) Pub. Date: Sep. 17, 2026

(54) QUANTIZATION-BASED DATA PROCESSING METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Guanghua YU, Shenzhen (CN)

(21) Appl. No.: 19/670,531

(22) Filed: May 7, 2026

Related U.S. Application Data
(63) Continuation of application No. PCT/CN2025/107278, filed on Jul. 7, 2025.

(30) Foreign Application Priority Data
Jul. 26, 2024 (CN) 202411010046.1

(51) Int. Cl. G06N 3/0495; G06N 3/08

(52) U.S. Cl. CPC G06N 3/0495; G06N 3/08

(57) ABSTRACT

A quantization-based data processing method includes: respectively performing quantization processing on an original model parameter corresponding to a model function network in a plurality of bit quantization manners, to obtain a plurality of quantized model parameters each corresponding to one of the plurality of bit quantization manners; acquiring a first output result of the model function network under the original model parameter, and acquiring a plurality of second output results of the model function network under the plurality of quantized model parameters; selecting a target bit quantization manner from the plurality of bit quantization manners based on the first output result and the plurality of second output results, the target bit quantization manner being configured to perform quantization processing on the original model parameter during an inference phase of the model function network.

### CROSS-REFERENCES TO RELATED APPLICATIONS

This application is a continuation of PCT Application No. PCT/CN2025/107278, filed on Jul. 7, 2025, which claims priority to Chinese Patent Application No. 202411010046.1, entitled “QUANTIZATION-BASED DATA PROCESSING METHOD AND APPARATUS, DEVICE, AND MEDIUM” and filed with the China National Intellectual Property Administration on Jul. 26, 2024, the entire contents of all of which are incorporated herein by reference.

### FIELD OF THE TECHNOLOGY

Embodiments of the present disclosure relate to the field of computer technologies, and specifically, to a quantization-based data processing method, a quantization-based data processing apparatus, an electronic device, and a computer-readable medium.

### BACKGROUND OF THE DISCLOSURE

Two solutions are usually used to determine bit quantization manner corresponding to different function networks of a Mixture of Experts (MoE). In Solution 1, the user selects a bit quantization manner for each function network according to human experience. In Solution 2, bit quantization manners are selected for function networks according to task types of the function networks. For example, a relatively high-bit bit quantization manner (for example, fp16 or int8) is selected for a function network with relatively high precision requirements for the task type, and a relatively low-bit bit quantization manner (for example, int4 or int2) is selected for a function network with relatively low precision requirements for the task type.

In Solution 1, insufficient human experience may lead to incorrect selection of bit quantization manners for function networks, reducing the accuracy of quantization processing, consequently affecting model performance. In Solution 2, the sensitivity of function networks may vary even for the same task type due to different models or different training phases of a model. Therefore, the selection of bit quantization manners according to task types of function networks is relatively fixed, which also has the problem of incorrect selection of bit quantization manners, reducing the accuracy of quantization processing, consequently affecting model performance.

Therefore, how to improve the accuracy of quantization processing to improve model performance is a problem to be resolved urgently.

### SUMMARY

Embodiments of the present disclosure provide a quantization-based data processing method and apparatus, a device, and a medium, which improves the accuracy of quantization processing, and achieves good model performance.

According to a first aspect, an embodiment of the present disclosure provides a quantization-based data processing method. The method includes: respectively performing quantization processing on an original model parameter corresponding to a model function network in a plurality of bit quantization manners, to obtain a plurality of quantized model parameters each corresponding to one of the plurality of bit quantization manners; acquiring a first output result of the model function network under the original model parameter, and acquiring a plurality of second output results of the model function network under the plurality of quantized model parameters; selecting a target bit quantization manner from the plurality of bit quantization manners based on the first output result and the plurality of second output results; generating a target quantization scale factor based on the target bit quantization manner; and performing, based on the target bit quantization manner and the target quantization scale factor, quantization processing on the original model parameter during an inference phase of the model function network.

According to a second aspect, an embodiment of the present disclosure provides a quantization-based data processing apparatus. The apparatus includes: a quantization processing module, configured to respectively perform quantization processing on an original model parameter corresponding to a model function network in a plurality of bit quantization manners, to obtain a plurality of quantized model parameters each corresponding to one of the plurality of bit quantization manners; an acquisition module, configured to acquire a first output result of the model function network under the original model parameter, and acquire a plurality of second output results of the model function network under the plurality of quantized model parameters; and a selection module, configured to select a target bit quantization manner from the plurality of bit quantization manners based on the first output result and the plurality of second output results, the target bit quantization manner being configured to perform quantization processing on the original model parameter during an inference phase corresponding to the model function network.

According to a third aspect, an embodiment of the present disclosure provides an electronic device, including: one or more processors; and a memory, configured to store one or more computer programs, the one or more computer programs, when executed by the one or more processors, causing the electronic device to implement the quantization-based data processing method described above.

According to a fourth aspect, an embodiment of the present disclosure provides a non-transitory computer-readable medium, having a computer program stored therein, the computer program, when executed by a processor, implementing the quantization-based data processing method described above.

In the technical solutions provided in the embodiments of the present disclosure, quantization processing is performed on an original model parameter corresponding to a model function network in a plurality of bit quantization manners, to obtain a plurality of quantized model parameters each corresponding to one of the plurality of bit quantization manners; and a target bit quantization manner is selected from the plurality of bit quantization manners based on a first output result of the model function network under the original model parameter and a plurality of second output results of the model function network under the plurality of quantized model parameters. Therefore, accurate selection of the bit quantization manner of the model function network is achieved, and accuracy of quantization processing is high. Moreover, the high accuracy of quantization processing helps improve the model's generalization capability beyond the training data, enabling the model to better adapt to new data distributions and scenarios; the model's stability and robustness are enhanced, enabling the model to maintain good performance under complex conditions; and inference can be performed more quickly, reducing unnecessary resource consumption, and improving resource utilization. Therefore, the model performance is greatly improved, enabling tasks in various application scenarios to be executed well by using the model.

The foregoing general descriptions and the following detailed descriptions are merely for illustration and explanation purposes and are not intended to limit the present disclosure.

### BRIEF DESCRIPTION OF THE DRAWINGS

FIG. 1 is a schematic diagram of an exemplary implementation environment to which a technical solution according to an embodiment of the present disclosure is applicable.

FIG. 2 is a flowchart of a quantization-based data processing method according to an exemplary embodiment of the present disclosure.

FIG. 3a is a schematic diagram of a data channel including channel values according to an exemplary embodiment of the present disclosure.

FIG. 3b is a schematic diagram of a data channel including channel values according to another exemplary embodiment of the present disclosure.

FIG. 4 is a flowchart of a quantization-based data processing method according to another exemplary embodiment of the present disclosure.

FIG. 5 is a schematic diagram of generating a target quantization scale factor according to an exemplary embodiment of the present disclosure.

FIG. 6 is a flowchart of a quantization-based data processing method according to another exemplary embodiment of the present disclosure.

FIG. 7 is a schematic diagram of generating a target bit quantization manner according to an exemplary embodiment of the present disclosure.

FIG. 8 is a block diagram of a quantization-based data processing apparatus according to an exemplary embodiment of the present disclosure.

FIG. 9 is a schematic structural diagram of a computer system adapted to implement an electronic device according to an embodiment of the present disclosure.

### DESCRIPTION OF EMBODIMENTS

Exemplary embodiments are described in detail herein, and examples of the exemplary embodiments are shown in the accompanying drawings. When the following descriptions are made with reference to the accompanying drawings, unless indicated otherwise, same numbers in different accompanying drawings represent the same or similar elements. The implementations described in the following exemplary embodiments do not represent all implementations that are consistent with the present disclosure. On the contrary, the implementations are merely examples of apparatuses and methods that are described in detail in the appended claims and that are consistent with some aspects of the present disclosure.

In this embodiment of the present disclosure, the term “module” or “unit” refers to a computer program or a part of a computer program that has a predetermined function and works together with other related parts to achieve a predetermined goal, and may be implemented in whole or in part by using software, hardware (such as a processing circuit or a memory) or a combination thereof. Similarly, one processor (or a plurality of processors or memories) may be used to implement one or more modules or units. In addition, each module or unit may be a part of an integral module or unit that includes the function of the module or unit.

The block diagrams shown in the accompanying drawings is merely a functional entity and does not necessarily correspond to a physically independent entity. To be specific, such functional entities may be implemented in the form of software, or implemented in one or more hardware modules or integrated circuits, or implemented in different networks and/or processor apparatuses and/or microcontroller apparatuses.

The flowcharts shown in the accompanying drawings are merely examples for descriptions, do not necessarily include all content and operations/steps, and are not necessarily performed in the described orders. For example, some operations/steps may be further divided, while some operations/steps may be combined or partially combined. Therefore, an actual execution order may vary depending on an actual situation.

“Plurality of” mentioned in the embodiments of the present disclosure means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

Before the technical solutions in the embodiments of the present disclosure is described, nouns and terms involved in the embodiments of the present disclosure are described first. The nouns and terms involved in the embodiments of the present disclosure are applicable to the following explanations.

Mixture of experts (MoE) is a neural network architecture configured to execute complex tasks. It divides an artificial intelligence (AI) model into separate subnetworks (or referred to as expert networks), and each subnetwork specializes in processing a subset of inputted data to collectively execute the task. The MoE includes a plurality of expert networks and a gating network. Each expert network is responsible for processing different aspects or sub-tasks of the inputted data. For example, in an image processing task, one expert network is configured to process edge detection, and another expert network is configured for texture recognition. The gating network is responsible for dynamically selecting one of the plurality of expert networks to process the current inputted data. The MoE effectively improve the model's capability to handle complex tasks and its performance by integrating the gating network and the plurality of expert networks.

Mixed bit quantization refers to performing mixing processing on analog signals and digital signals. By dividing an inputted signal into a plurality of segments and compressing each segment in different quantization manners, a digital signal formed by a plurality of binary codes of different quantities of bits is finally obtained. Mixed bit quantization can effectively improve the data compression ratio and the signal quality. Mixed bit quantization is a method for optimizing model inference, which may be applied to the MoE, and different quantization precisions are allowed to be used in the same model to balance the computational efficiency and precision requirements of the model. Specifically, during model inference, different expert networks (also referred to as function networks) may use different quantization precisions. For example, some function networks use int8 (an 8-bit integer representation) for quantization, some function networks use int4 (a 4-bit integer representation) for quantization, some function networks use int2 (a 2-bit integer representation) for quantization, and some function networks use fixed point 16-bit (fp16, a 16-bit floating-point number representation) for quantization, and the like.

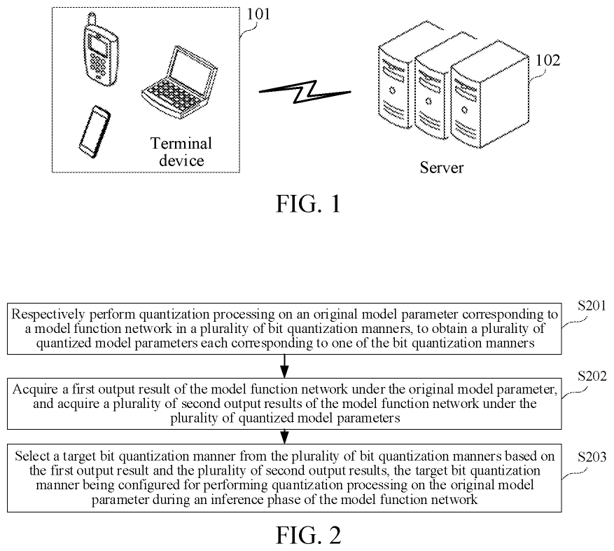

The two solutions described above are used in the related art to select bit quantization manners for function networks, but the accuracy of quantization processing is not high, consequently affecting the model performance. Therefore, in order to improve the accuracy of quantization processing to improve the model performance, the embodiments of the present disclosure provide a quantization-based data processing solution. FIG. 1 is a schematic diagram of an implementation environment according to an embodiment of the present disclosure. The implementation environment includes a terminal device 101 and a server 102.

The terminal device 101 includes, but not limited to, a smartphone, a computer (a tablet computer, a notebook computer, a desktop computer, or the like), a smart home device (a television, a refrigerator, an air conditioner, a washing machine, a sweeping and mopping robot, or the like), a smart wearable device (a bracelet, a watch, or the like), and the like.

The server 102 may be an independent physical server, or may be a server cluster or a distributed system formed by a plurality of physical servers. The server cluster or distributed system includes a cloud server configured to provide basic cloud computing services such as a cloud service, a cloud database, cloud computing, a cloud function, cloud storage, a network service, cloud communication, a middleware service, a domain name service, a security service, a content delivery network (CDN), big data, and an AI platform, and the like.

In an embodiment, the terminal device 101 and the server 102 establish a communication connection through a wired or wireless network. For example, a standard communication technology and/or protocol is used for the wireless network or the wired network. The network is usually the Internet, but may alternatively be any other network, including but not limited to, any combination of a local area network (LAN), a metropolitan area network (MAN), a wide area network (WAN), a mobile, wired, or wireless network, and a dedicated network or a virtual dedicated network.

In an embodiment of the present disclosure, the quantization-based data processing method may be performed by the server 102. Specifically, the server 102 respectively performs quantization processing on an original model parameter corresponding to a model function network in a plurality of bit quantization manners, to obtain a plurality of quantized model parameters each corresponding to one of the plurality of bit quantization manners; then acquires a first output result of the model function network under the original model parameter, and acquires a plurality of second output results of the model function network under the plurality of quantized model parameters; and then selects a target bit quantization manner from the plurality of bit quantization manners based on the first output result and the plurality of second output results, the target bit quantization manner being configured to perform quantization processing on the original model parameter during an inference phase of the model function network.

In an embodiment of the present disclosure, the quantization-based data processing method may be performed by the terminal device 101 alone or by the terminal device 101 and the server 102 together. In practical applications, the execution subject of the quantization-based data processing method may be flexibly adjusted according to specific application scenarios.

The quantity of terminal devices 101 and the quantity of servers 102 shown in FIG. 1 are merely exemplary. There may be any quantity of terminal devices 101 and any quantity of servers 102 according to actual needs.

In specific implementations of the present disclosure, user-related data is involved. When the embodiments of the present disclosure are applied to a specific product or technology, user permission or consent needs to be obtained, and the collection, use, and processing of relevant data need to comply with relevant laws, regulations, and standards of relevant countries and regions.

The various implementation details of the technical solutions in the embodiments of the present disclosure are described below in detail.

FIG. 2 is a flowchart of a quantization-based data processing method according to an embodiment of the present disclosure. As shown in FIG. 2, the quantization-based data processing method includes at least operations S201 to S203, which are described in detail as follows.

S201: Respectively perform quantization processing on an original model parameter corresponding to a model function network in a plurality of bit quantization manners, to obtain a plurality of quantized model parameters each corresponding to one of the plurality of bit quantization manners.

In this embodiment of the present disclosure, the bit quantization manners include, but not limited to, at least one of the following: integer representation of arbitrary bits, floating-point number representation of arbitrary bits, or the like, where the arbitrary bits may be 2, 3, 4, 6, 8, 16, 32, 64, 128, and the like.

In this embodiment of the present disclosure, the original model parameter refers to a model parameter of a function network of the MoE (referred to as the model function network for short) before quantization processing is performed in the bit quantization manners. Correspondingly, the quantized model parameters refer to model parameters of the model function network after quantization processing is performed in the bit quantization manners. The model parameter includes, but not limited to, at least one of a weight value (weight), an activation input value (activation), a cached value (KV-Cache), or the like. In this embodiment of the present disclosure, the model parameter being a weight value is used as an example. The original model parameter is an original weight value, the quantized model parameters are quantized weight values, and the rest can be deduced by analogy.

In this embodiment of the present disclosure, quantization processing is respectively performed on the original model parameter in a plurality of bit quantization manners, to obtain quantized model parameters respectively corresponding to the plurality of bit quantization manners.

For example, it is assumed that the plurality of bit quantization manners are int2, int4, and int8 respectively, w0 is used to represent the original weight value, and winti is used to represent the quantized weight value corresponding to the bit quantization manner inti, then the quantized weight value corresponding to int2 is wint2=int2(w0), the quantized weight value corresponding to int4 is wint4=int4(w0), and the quantized weight value corresponding to int8 is wint8=int8(w0).

S202: Acquire a first output result of the model function network under the original model parameter, and acquire a plurality of second output results of the model function network under the plurality of quantized model parameters.

In this embodiment of the present disclosure, after the quantized model parameter corresponding to each bit quantization manner is obtained, a first output result of the model function network under the original model parameter can be acquired, and a plurality of second output results of the model function network under the plurality of quantized model parameters can be acquired.

In this embodiment of the present disclosure, the first output result refers to a result outputted by the model function network under the original model parameter, and the second output results refer to results outputted by the model function network under the quantized model parameters.

In an embodiment of the present disclosure, the original model parameter includes an original weight value, and the quantized model parameter includes a quantized weight value; and correspondingly, the process of acquiring a first output result of the model function network under the original model parameter, and acquiring a plurality of second output results of the model function network under the plurality of quantized model parameters in S202 may include the following operations:
acquiring an activation input value of the model function network; and
performing a product operation on the activation input value and the original weight value, to obtain the first output result of the model function network, and performing a product operation on the activation input value and each quantized weight value, to obtain the plurality of second output results of the model function network.

For example, continuing the foregoing example, a is used to represent the activation input value, out0 is used to represent the first output result, and outinti is used to represent the second output result corresponding to the bit quantization manner inti, then the first output result is out0=a×w0, the second output result corresponding to int2 is outint2=a×wint2, the second output result corresponding to int4 is outint4=a×wint4, and the second output result corresponding to int8 is outint8=a×wint8.

In this way, based on the embodiment, the first output result and the plurality of second output results can be obtained easily and accurately.

In an embodiment of the present disclosure, the model function network corresponds to a plurality of data channels, and each data channel corresponds to one or more channel values. In specific implementations, each data channel usually corresponds to a plurality of channel values, for example, at least three. The channel value refers to a key parameter configured for distinguishing different types of channel data during reading of channel data of data channels.

In an embodiment, the process of acquiring an activation input value of the model function network may include the following operations:
detecting whether an outlier channel value exists in each of the plurality of data channels, where the outlier channel value refers to that there may be at least one channel value differing significantly from other channel values in the plurality of channel values corresponding to a data channel, for example, a difference between the at least one channel value and the other channel values is greater than a preset threshold; and
if it is detected that outlier channel values exist, comparing all detected outlier channel values, using a data channel corresponding to a largest outlier channel value as a target data channel, using channel values corresponding to the target data channel as the activation input value of the model function network, and acquiring an original weight value and quantized weight values that are corresponding to the target data channel. For example, continuing the foregoing example, a is used to represent the activation input value, and a is a vector matrix [N, M], where N is a parameter related to the input of the model function network, and M is a preset size of a hidden layer of the model function network. In this embodiment of the present disclosure, N and M are integers greater than 1. N may be a length of a text sequence that is inputted to the model function network and that is determined according to the channel values corresponding to the target data channel. For example, if the length of the text sequence is 4096 characters, N is equal to 4096, and M may be a preset value, such as 2048 or 4096.

Correspondingly, the process of performing a product operation on the activation input value and the original weight value, to obtain the first output result of the model function network, and performing a product operation on the activation input value and each quantized weight value, to obtain the plurality of second output results of the model function network may include the following operations:
performing a product operation on the channel values and the original weight value that are corresponding to the target data channel, to obtain the first output result of the model function network, and performing a product operation on the channel values and each quantized weight value that are corresponding to the target data channel, to obtain the plurality of second output results of the model function network.

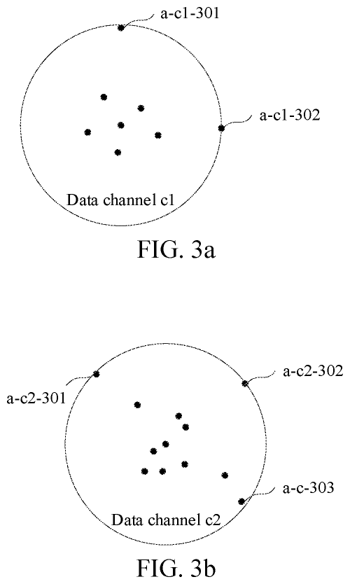

The outlier channel values in the embodiment are for data channels. For example, FIG. 3a shows a data channel c1 including a plurality of channel values. As shown in FIG. 3a, a-c1-301 and a-c1-302 are both outlier channel values. FIG. 3b shows a data channel c2 including a plurality of channel values. As shown in FIG. 3b, a-c2-301, a-c2-302, and a-c3-303 are all outlier channel values.

In this embodiment, the largest channel value is selected from the plurality of outlier channel values, and the data channel corresponding to the largest channel value is used as the target data channel. For example, continuing the foregoing example, it is assumed that a-c1-301 is the largest among a-c1-301, a-c1-302, a-c2-301, a-c2-302, and a-c3-303, then the data channel c1 is the target data channel.

In an embodiment, there may alternatively be only one outlier channel value, then the data channel corresponding to the outlier channel value is the target data channel.

In this embodiment, the channel values corresponding to the target data channel are used as the activation input value of the model function network. For example, continuing the foregoing example, as shown in FIG. 3a, all the channel values included in the data channel c1 are the activation input value of the model function network.

In this embodiment, a product operation is performed on the channel values corresponding to the target data channel and the original weight value corresponding to the target data channel, to obtain a first output result of the target data channel, and in this case, the first output result of the target data channel is the first output result of the model function network; and a product operation is performed on the channel values corresponding to the target data channel and each quantized weight value corresponding to the target data channel, to obtain a plurality of second output results of the target data channel, and in this case, the plurality of second output results of the target data channel are the plurality of second output results of the model function network.

For example, continuing the foregoing example in which the data channel c1 is used as the target data channel, a-c1 is used to represent the plurality of channel values (that is, a plurality of points in FIG. 3a) corresponding to the target data channel c1. If the size of the data channel c1 is 2048, c1 has 2048 channel values. Therefore, a-c1 is a vector matrix [N, M] determined according to the size of the data channel c1, where N is 2048, and M is a preset size of the hidden layer of the model function network. Therefore, the first output result of the target data channel c1 is out0-c1=(a-c1)×w0, the second output result of the target data channel c1 using int2 is outint2-c1=(a-c1)×wint2, the second output result of the target data channel c1 using int4 is outint4-c1=(a-c1)×wint4, and the second output result of the target data channel c1 using int8 is outint8-c1=(a-c1)×wint8.

In this way, based on the embodiment, because the largest outlier channel value can reflect the sensitivity of the model function network to a certain extent, when the data channel corresponding to the largest outlier channel value in the model function network is used as the target data channel, the accuracy of the first output result and the plurality of second output results obtained through calculation is higher.

In an embodiment of the present disclosure, the process of using channel values corresponding to the target data channel as the activation input value of the model function network may include the following operations:
calculating a similarity between the target data channel and an adjacent data channel corresponding to the target data channel;
reducing outlier channel values in the target data channel based on the similarity, to obtain target channel values; and
using the target channel values and channel values in the target data channel other than the outlier channel values as the activation input value of the model function network.

That is, in this embodiment, the similarity between the target data channel and the adjacent data channel corresponding to the target data channel is used to reduce the outlier channel values in the target data channel, to obtain target channel values. In this case, the target channel values and the channel values in the target data channel other than the outlier channel values (that is, other channel values) are the activation input value of the model function network.

For example, continuing the foregoing example in which the data channel c1 is used as the target data channel, c1′ is used to represent an adjacent data channel of the target data channel c1. A similarity s between the target data channel c1 and the adjacent data channel c1′ is first calculated, and then the similarity s is used to reduce the outlier channel values a-c1-301 and a-c1-302 in the target data channel c1 respectively, to obtain a target channel value a-c1-301′ corresponding to the outlier channel value a-c1-301 and a target channel value a-c1-302′ corresponding to the outlier channel value a-c1-302. In this case, the target channel value a-c1-301′, the target channel value a-c1-302′, and channel values in a-c1 corresponding to the target data channel c1 other than the outlier channel values a-c1-301 and a-c1-302 are the activation input value of the model function network.

In this way, based on the embodiment, the outlier channel values in the target data channel are reduced, so that smaller values are used to represent the target data channel, to obtain the activation input value of the model function network. This helps to select a lower-precision bit quantization manner for the model function network subsequently.

In an embodiment of the present disclosure, the process of calculating a similarity between the target data channel and an adjacent data channel corresponding to the target data channel may include the following operations:
performing a distance operation based on the channel values of the target data channel and channel values of the adjacent data channel corresponding to the target data channel to obtain a distance value, the distance value being greater than 0 and less than 1, and using the distance value as the similarity between the target data channel and the adjacent data channel; and
correspondingly, the reducing outlier channel values in the target data channel based on the similarity, to obtain target channel values includes:
performing a product operation on the distance value and the outlier channel values in the target data channel, to obtain the target channel values.

That is, in this embodiment, the channel values of the adjacent data channel corresponding to the target data channel are first determined, where there are usually a plurality of channel values of the adjacent data channel; then a distance operation is performed on each channel value of the target data channel and the channel values of the adjacent data channel to obtain distance values; then an average operation is performed on all the obtained distance values to obtain an average distance value, where the average distance value is a similarity between the target data channel and the adjacent data channel; and subsequently, the distance value is used to reduce the outlier channel values in the target data channel, thereby obtaining the target channel values.

In this embodiment, a distance algorithm is used to calculate the distance value between the target data channel and the adjacent data channel. The distance algorithm includes, but not limited to, at least one of cosine similarity, Euclidean distance, Manhattan distance, Chebyshev distance, Minkowski distance, or the like.

For example, continuing the foregoing example, it is assumed that the distance algorithm is cosine similarity, then a distance value between the target data channel c1 and the adjacent data channel c1′ is

$$cos θ = \frac{c 1 \times c {1}^{′}}{‖ c 1 ‖ ‖ c {1}^{′} ‖} ,$$

where c1 and c1′ are vector matrices.

In this embodiment, the distance value between the target data channel and the adjacent data channel is obtained, then a product operation may be performed on the distance value and the outlier channel values in the target data channel, to obtain the target channel values.

For example, continuing the foregoing example, the outlier channel values are a-c1-301 and a-c1-302, then the target channel value a-c1-301′=cos θ×(a-c1-301) and the target channel value a-c1-302′=cos θ×(a-c1-302). Because 0<cos θ<1, the target channel value a-c1-301′ is less than a-c1-301, and the target channel value a-c1-302′ is less than a-c1-302.

In this way, based on the embodiment, the target channel values can be easily and accurately obtained.

S203: Select a target bit quantization manner from the plurality of bit quantization manners based on the first output result and the plurality of second output results, the target bit quantization manner being configured to perform quantization processing on the original model parameter during an inference phase of the model function network.

In this embodiment of the present disclosure, after the first output result and the plurality of second output results are obtained, the target bit quantization manner may be selected from the plurality of bit quantization manners based on the first output result and the plurality of second output results. The target bit quantization manner is configured to perform quantization processing on the original model parameter during an inference phase of the model function network.

In an embodiment of the present disclosure, the process of selecting a target bit quantization manner from the plurality of bit quantization manners based on the first output result and the plurality of second output results in S203 may include the following operations:
calculating a difference value between the first output result and each second output result; and
selecting a bit quantization manner corresponding to a smallest difference value from the plurality of bit quantization manners, and using the selected bit quantization manner as the target bit quantization manner.

That is, in this embodiment, a difference value between the first output result and each second output result is first calculated, and then a bit quantization manner corresponding to a smallest difference value is selected from the plurality of bit quantization manners. In this case, the selected bit quantization manner is the target bit quantization manner. A smaller difference value indicates a smaller impact on an output result before and after the use of the bit quantization manner. Therefore, in this embodiment, the bit quantization manner corresponding to the smallest difference value is used as the target bit quantization manner.

For example, continuing the foregoing example, it is assumed that a difference value between the first output result out0 and the second output result outint2 is calculated to be Lout0-outint2, a difference value between the first output result out0 and the second output result outint4 is calculated to be Lout0-outint4, a difference value between the first output result out0 and the second output result outint8 is calculated to be Lout0-outint8, and Lout0-outint2 is the smallest among Lout0-outint2, Lout0-outint4, and Lout0-outint8. Therefore, int2 corresponding to Lout0-outint2 is selected from the plurality of bit quantization manners int2, int4, and int8 as the target bit quantization manner.

In this way, based on the embodiment, based on calculation of the difference value, the target bit quantization manner can be easily and accurately selected from the plurality of bit quantization manners.

In an embodiment of the present disclosure, the process of calculating a difference value between the first output result and each second output result may include the following operations:
for each second output result, performing a difference operation on the first output result and the second output result to obtain a difference, and raising the obtained difference to a specified power to obtain a difference value between the first output result and the second output result.

In this embodiment, the specified power may be a square, and in this case, the difference value between the first output result and each second output result is calculated by using a mean squared error (MSE) algorithm.

For example, continuing the foregoing example, Lout0-outint2=(out0−outint2)², Lout0-outint4=(out0-outint4)², and Lout0-outint8=(out0-outint8)².

In this way, based on the embodiment, the difference value between the first output result and each second output result can be easily and accurately obtained.

In an embodiment of the present disclosure, the process of calculating a difference value between the first output result and each second output result may include the following operations:
for each second output result, calculating a signal power value based on the second output result, calculating a noise power value based on the first output result and the second output result, calculating a signal-to-noise ratio based on the signal power value and the noise power value, and calculating a difference value between the first output result the second output result based on the signal-to-noise ratio.

That is, in this embodiment, the difference value between the first output result and each second output result is calculated by using a signal-to-noise ratio (SNR) algorithm.

For example, continuing the foregoing example, the calculation of the difference value Lout0-outint2 between the first output result out0 and the second output result outint2 is used as an example. Psignal is used to represent the signal power value, then

$$Psignal = \frac{outint {2}^{2}}{2} ;$$

Pnoise is used to represent the noise power value, then

$$Pnoise = \frac{{( out 0 - outint 2 )}^{2}}{2} ;$$

and SNR is used to represent the signal-to-noise ratio, then

$$SNR = \frac{Psignal}{Pnoise} .$$

Correspondingly, Lout0-outint2=−SNR. Other difference values can be deduced by analogy, and details are not described herein again.

In this way, based on the embodiment, the difference value between the first output result and each second output result can be easily and accurately obtained.

In an embodiment of the present disclosure, the process of selecting a bit quantization manner corresponding to a smallest difference value from the plurality of bit quantization manners may include the following operations:
selecting a difference value less than a preset difference threshold from the plurality of difference values; and
if there are a plurality of selected difference values, selecting a bit quantization manner corresponding to the smallest difference value from the plurality of bit quantization manners.

That is, in this embodiment, a difference value less than the preset difference threshold is first selected from the plurality of difference values as a candidate difference value, and when there are a plurality of candidate difference values, the bit quantization manner corresponding to the smallest candidate difference value is selected from the plurality of bit quantization manners.

For example, continuing the foregoing example, it is assumed that the preset difference threshold is 0.001, and Lout0-outint2 and Lout0-outint4 are both less than 0.001 among Lout0-outint2, Lout0-outint4, and Lout0-outint8. In this case, Lout0-outint2 and Lout0-outint4 are candidate difference values. It is also assumed that in Lout0-outint2 and Lout0-outint4, Lout0-outint2 is smaller, then int2 corresponding to Lout0-outint2 is selected from the plurality of bit quantization manners int2, int4, and int8 as the target bit quantization manner. In practical applications, the preset difference threshold may be flexibly set according to specific application scenarios.

In this way, based on the embodiment, the preset difference threshold is first used for an initial screening, and then a second screening is performed by comparing the difference values, so that the target bit quantization manner can be accurately obtained.

In an embodiment of the present disclosure, the process of selecting a bit quantization manner corresponding to a smallest difference value from the plurality of bit quantization manners may include the following operations:
selecting the smallest difference value from the plurality of difference values; and
if the selected difference value is less than the preset difference threshold, selecting a bit quantization manner corresponding to the selected difference value from the plurality of bit quantization manners.

That is, in this embodiment, the smallest difference value is first selected from the plurality of difference values as a candidate difference value, and when the candidate difference value is less than the preset difference threshold, the bit quantization manner corresponding to the candidate difference value is selected from the plurality of bit quantization manners.

For example, continuing the foregoing example, it is assumed that Lout0-outint2 is the smallest among Lout0-outint2, Lout0-outint4, and Lout0-outint8. In this case, Lout0-outint2 is a candidate difference value. It is also assumed that the preset difference threshold is 0.001, and Lout0-outint2 is less than 0.001, then int2 corresponding to Lout0-outint2 is selected from the plurality of bit quantization manners int2, int4, and int8 as the target bit quantization manner. In practical applications, the preset difference threshold may be flexibly set according to specific application scenarios.

In this way, based on the embodiment, an initial screening is first performed by comparing the difference values, and then the preset difference threshold is used for a second screening, so that the target bit quantization manner can be accurately obtained.

In an embodiment, there may be one or more model function networks in S201 to S203 shown in FIG. 2. When there is one model function network, a target bit quantization manner corresponding to the model function network is finally obtained. When there are a plurality of model function networks, a target bit quantization manner corresponding to each model function network is finally obtained. Target bit quantization manners corresponding to different model function networks may be the same or different.

Table 1 is an example table of target bit quantization manners respectively corresponding to a plurality of model function networks.

TABLE 1

| Model function | Target bit |
|---|---|
| network | quantization manner |
| E1 | int2 |
| E2 | int4 |
| E3 | int8 |

In the embodiments of the present disclosure, quantization processing is performed on an original model parameter corresponding to a model function network in a plurality of bit quantization manners, to obtain a plurality of quantized model parameters each corresponding to one of the plurality of bit quantization manners; and a target bit quantization manner is selected from the plurality of bit quantization manners based on a first output result of the model function network under the original model parameter and a plurality of second output results of the model function network under the plurality of quantized model parameters. Therefore, accurate selection of the bit quantization manner of the model function network is achieved, and accuracy of quantization processing is high, which helps improve the model's generalization capability beyond the training data, enabling the model to better adapt to new data distributions and scenarios; the model's stability and robustness are enhanced, enabling the model to maintain good performance under complex conditions; and inference can be performed more quickly, reducing unnecessary resource consumption, and improving resource utilization. Therefore, the model performance is greatly improved, enabling tasks in various application scenarios to be executed well by using the model.

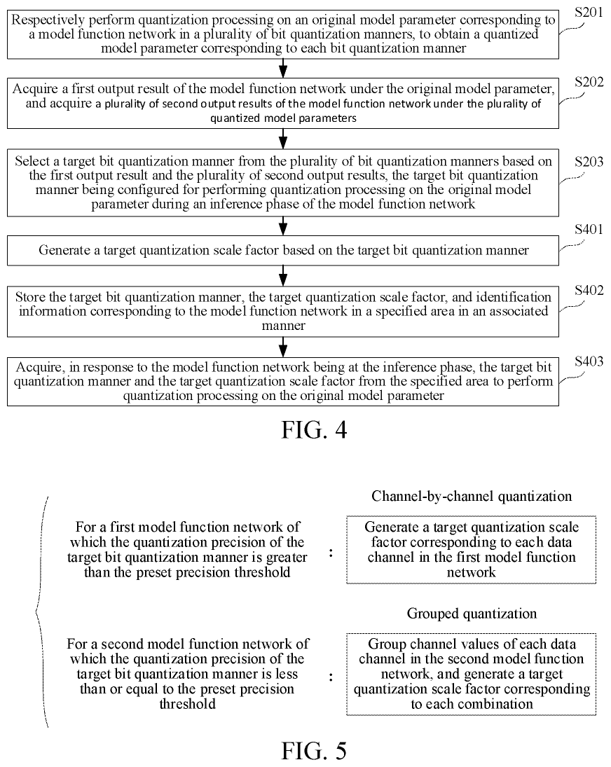

In an embodiment of the present disclosure, another quantization-based data processing method is provided. As shown in FIG. 4, the quantization-based data processing method may further include operations S401 to S403 after S203. In some embodiments, the quantization-based data processing method may further include operations S401 and an operation of performing quantization processing on the original model parameter after S203.

A detailed description of S401 to S403 is as follows:
S401: Generate a target quantization scale factor based on the target bit quantization manner.

In an embodiment, the process of performing quantization in a bit quantization manner in a function network involves the use of a quantization scale factor. The quantization scale factor is mainly configured for mapping data of a relatively high precision type (for example, int8) to a representation range corresponding to a relatively low precision type (for example, int2). Therefore, in this embodiment, after the target bit quantization manner is obtained, the target quantization scale factor corresponding to the model function network may be generated in the target bit quantization manner. In one example, in response to a quantization precision of the target bit quantization manner being greater than a preset precision threshold, the target quantization scale factor corresponding to each data channel in the model function network can be generated. In another example, in response to the quantization precision of the target bit quantization manner being less than or equal to the preset precision threshold, channel values of each data channel in the model function network can be grouped to obtain a plurality of combinations, and the target quantization scale factor corresponding to each combination can be generated.

In an embodiment of the present disclosure, there are a plurality of model function networks. For example, as shown in Table 1, the plurality of model function networks are E1, E2, and E3 respectively.

Correspondingly, the process of generating a target quantization scale factor based on the target bit quantization manner in S401 may include at least two cases:

Case 1: If a first model function network of which a quantization precision of a target bit quantization manner is greater than a preset precision threshold exists in the plurality of model function networks, a target quantization scale factor corresponding to each data channel in the first model function network is generated.

In this embodiment, the first model function network refers to a model function network of which the quantization precision of the target bit quantization manner is greater than the preset precision threshold in the plurality of model function networks.

For example, continuing the foregoing example, it is assumed that the preset precision threshold is int4, then referring to Table 1, it can be learned that the quantization precision int8 of the model function network E3 is greater than the preset precision threshold int4. In this case, the model function network E3 is the first model function network.

In this embodiment, after the first model function network is obtained, a target quantization scale factor corresponding to each data channel in the first model function network may be generated.

For example, continuing the foregoing example in which the model function network E3 is the first model function network, it is assumed that the model function network E3 includes 64 data channels. Correspondingly, target quantization scale factors respectively corresponding to the 64 data channels are generated.

Case 2: If a second model function network of which a quantization precision of a target bit quantization manner is less than or equal to the preset precision threshold exists in the plurality of model function networks, channel values of each data channel in the second model function network are grouped, and a target quantization scale factor corresponding to each combination is generated.

In this embodiment, the second model function network refers to a model function network of which the quantization precision of the target bit quantization manner is less than or equal to the preset precision threshold in the plurality of model function networks.

For example, continuing the foregoing example, it is assumed that the preset precision threshold is int4, then referring to Table 1, it can be learned that the quantization precision int2 of the model function network E1 is less than the preset precision threshold int4, and the quantization precision int4 of the model function network E2 is equal to the preset precision threshold int4. In this case, both the model function networks E1 and E2 are second model function networks.

In this embodiment, after the second model function network is obtained, channel values of each data channel in the second model function network may be grouped, and a target quantization scale factor corresponding to each combination may be generated.

For example, continue the foregoing example in which the model function networks E1 and E2 are second model function networks.

For the model function network E2, it is assumed that the model function network E2 includes 64 data channels, and each data channel has 128 channel values. Each 64 channel values may be one combination, that is, the channel values of each data channel are divided into two combinations, so that there are 128 combinations in total. Correspondingly, target quantization scale factors respectively corresponding to the 128 combinations are generated.

For the model function network E1, it is assumed that the model function network E1 includes 128 data channels, and each data channel has 128 channel values. Each 64 channel values may be one combination, that is, the channel values of each data channel are divided into two combinations, so that there are 256 combinations in total. Correspondingly, target quantization scale factors respectively corresponding to the 256 combinations are generated.

In an embodiment, different model function networks may include the same or different quantities of data channels, and during grouping, the channel values included in each combination may be flexibly adjusted according to specific application scenarios.

In this way, based on the embodiment, when the quantization precision of the target bit quantization manner corresponding to the model function network is relatively high, the target quantization scale factor is calculated based on coarser-grained data channels, thereby saving computational resources, time, and the like. When the quantization precision of the target bit quantization manner corresponding to the model function network is relatively low, the target quantization scale factor is calculated based on finer-grained combinations, thereby maximizing the quantization precision and ensuring the accuracy of quantization processing.

For ease of understanding, referring to FIG. 5, for a first model function network of which the quantization precision of the target bit quantization manner is greater than the preset precision threshold, a target quantization scale factor corresponding to each data channel in the first model function network is generated (that is, channel-by-channel quantization); and for a second model function network of which the quantization precision of the target bit quantization manner is less than or equal to the preset precision threshold, channel values of each data channel in the second model function network are grouped, and a target quantization scale factor corresponding to each combination is generated (that is, grouped quantization).

In an embodiment of the present disclosure, the process of generating a target quantization scale factor corresponding to each data channel in the first model function network may include the following operations:
acquiring the target bit quantization manner corresponding to the first model function network; and
for each data channel in the first model function network, performing an operation based on the acquired target bit quantization manner, an activation input value corresponding to the data channel, and each quantization scale factor, to obtain an operation result corresponding to the each quantization scale factor, and using a quantization scale factor corresponding to an operation result with a largest absolute value in a plurality of operation results as a target quantization scale factor of the data channel.

That is, in this embodiment, for each data channel in the first model function network, an operation is performed based on the target bit quantization manner corresponding to the first model function network, the activation input value corresponding to the data channel, and each quantization scale factor, to obtain an operation result corresponding to the each quantization scale factor. In this case, the quantization scale factor corresponding to the operation result with the largest absolute value in the plurality of operation results is the target quantization scale factor of the data channel. A larger absolute value of the operation result reflects a more significant change in the data channel, so that more attention is paid to the sensitivity of the model function network.

In this way, based on the embodiment, the target quantization scale factor of each data channel in the first model function network can be easily and accurately obtained.

In an embodiment of the present disclosure, the process of performing an operation based on the acquired target bit quantization manner, an activation input value corresponding to the data channel, and each quantization scale factor, to obtain an operation result corresponding to the each quantization scale factor may include the following operations:
traversing a first quantization scale factor in a first scale factor list, and performing an operation based on the acquired target bit quantization manner, the activation input value corresponding to the data channel, and the traversed quantization scale factor, to obtain an operation result corresponding to the traversed quantization scale factor; and
updating the activation input value corresponding to the data channel, traversing a next adjacent quantization scale factor of the first quantization scale factor, performing an operation based on the acquired target bit quantization manner, the updated activation input value, and the traversed quantization scale factor to obtain an operation result corresponding to the traversed quantization scale factor, and repeating the process until the first scale factor list is completely traversed, to obtain an operation result corresponding to each quantization scale factor in the first scale factor list.

That is, in this embodiment, the operation result corresponding to each quantization scale factor is obtained through traversing and calculation. Specifically, firstly, the first quantization scale factor in the first scale factor list is traversed, and an operation is performed based on the target bit quantization manner corresponding to the first model function network, the activation input value corresponding to the data channel, and the first quantization scale factor, to obtain an operation result corresponding to the first quantization scale factor; and then the activation input value of the data channel is updated, a next adjacent quantization scale factor of the first quantization scale factor (that is, the second quantization scale factor in the first scale factor list) is traversed, and an operation is performed based on the target bit quantization manner corresponding to the first model function network, the updated activation input value, and the second quantization scale factor to obtain an operation result corresponding to the second quantization scale factor. The process is repeated until the first scale factor list is completely traversed, to obtain an operation result corresponding to each quantization scale factor in the first scale factor list.

In this embodiment, updating the activation input value of the data channel in each iteration process may be finding the maximum absolute value of the activation input value of the data channel sampled in the current iteration process and the activation input value of the data channel sampled in the previous iteration process. If an absolute value of the activation input value of the data channel sampled in the current iteration process is less than an absolute value of the activation input value of the data channel sampled in the previous iteration process, the activation input value of the data channel sampled in the current iteration process is updated to the activation input value of the data channel sampled in the previous iteration process. If the absolute value of the activation input value of the data channel sampled in the current iteration process is greater than or equal to the absolute value of the activation input value of the data channel sampled in the previous iteration process, the activation input value of the data channel sampled in the current iteration process is maintained. The sampled activation input value of the data channel refers to an activation input value obtained by performing model prediction on inputted data of the model.

In this way, based on the embodiment, the activation input value of the data channel is updated in the iteration process, thereby improving the accuracy of operation results corresponding to quantization scale factors.

In an embodiment of the present disclosure, the process of generating a target quantization scale factor corresponding to each combination may include the following operations:
acquiring the target bit quantization manner corresponding to the second model function network; and
for each combination corresponding to each data channel in the second model function network, performing a plurality of operation based on the target bit quantization manner, an activation input value corresponding to the combination, and a plurality of quantization scale factors, to obtain a plurality of operation results each corresponding to on, and using a quantization scale factor corresponding to an operation result with a largest absolute value in a plurality of operation results as a target quantization scale factor of the combination.

That is, in this embodiment, for each combination corresponding to each data channel in the first model function network, an operation is performed based on the target bit quantization manner corresponding to the second model function network, the activation input value corresponding to the combination, and each quantization scale factor, to obtain an operation result corresponding to the each quantization scale factor. In this case, the quantization scale factor corresponding to the operation result with the largest absolute value in the plurality of operation results is the target quantization scale factor of the combination. A larger absolute value of the operation result reflects a more significant change in the combination, so that more attention is paid to the sensitivity of the model function network.

In this way, based on the embodiment, the target quantization scale factor of each combination of each data channel in the second model function network can be easily and accurately obtained.

In an embodiment of the present disclosure, the process of performing a plurality of operation based on the target bit quantization manner, an activation input value corresponding to the combination, and a plurality of quantization scale factors, to obtain a plurality of operation results each corresponding to on may include the following operations:
traversing a first quantization scale factor in a second scale factor list, and performing an operation based on the acquired target bit quantization manner, the activation input value corresponding to the combination, and the traversed quantization scale factor, to obtain an operation result corresponding to the traversed quantization scale factor; and
updating the activation input value corresponding to the combination, traversing a next adjacent quantization scale factor of the first quantization scale factor, performing an operation based on the acquired target bit quantization manner, the updated activation input value, and the traversed quantization scale factor to obtain an operation result corresponding to the traversed quantization scale factor, and repeating the process until the second scale factor list is completely traversed, to obtain an operation result corresponding to each quantization scale factor in the second scale factor list.

That is, in this embodiment, the operation result corresponding to each quantization scale factor is obtained through traversing and calculation. Specifically, firstly, the first quantization scale factor in the second scale factor list is traversed, and an operation is performed based on the target bit quantization manner corresponding to the second model function network, the activation input value corresponding to the combination, and the first quantization scale factor, to obtain an operation result corresponding to the first quantization scale factor; and then the activation input value of the combination is updated, a next adjacent quantization scale factor of the first quantization scale factor (that is, the second quantization scale factor in the second scale factor list) is traversed, and an operation is performed based on the target bit quantization manner corresponding to the second model function network, the updated activation input value, and the second quantization scale factor to obtain an operation result corresponding to the second quantization scale factor. The process is repeated until the second scale factor list is completely traversed, to obtain an operation result corresponding to each quantization scale factor in the second scale factor list.

In this embodiment, updating the activation input value of the combination in each iteration process may be finding the maximum absolute value of the activation input value of the combination sampled in the current iteration process and the activation input value of the combination sampled in the previous iteration process. If an absolute value of the activation input value of the combination sampled in the current iteration process is less than an absolute value of the activation input value of the combination sampled in the previous iteration process, the activation input value of the combination sampled in the current iteration process is updated to the activation input value of the combination sampled in the previous iteration process. If the absolute value of the activation input value of the combination sampled in the current iteration process is greater than or equal to the absolute value of the activation input value of the combination sampled in the previous iteration process, the activation input value of the combination sampled in the current iteration process is maintained.

In this way, based on the embodiment, the activation input value of the combination is updated in the iteration process, thereby improving the accuracy of operation results corresponding to quantization scale factors.

In an embodiment of the present disclosure, the process of generating a target quantization scale factor based on the target bit quantization manner in S401 may include the following operations:
respectively obtaining quantization scale factors corresponding to the target bit quantization manner by using a plurality of devices on which a mixed bit quantization model is deployed; and
selecting a largest quantization scale factor from the plurality of quantization scale factors as the target quantization scale factor.

That is, in this embodiment, considering the situation of limited device resources, quantization scale factors corresponding to the target bit quantization manner are respectively obtained by using a plurality of devices on which a mixed bit quantization model is deployed, and the largest quantization scale factor is selected from the plurality of quantization scale factors as the target quantization scale factor.

The mixed bit quantization model refers to that a plurality of model function networks included in the model use different bit quantization manners, where the bit quantization manners include int2, int4, int8, bf16, and the like. For example, mixed bit quantization models are deployed on three devices respectively, and these three devices may use different bit quantization manners. The model function network E1 is used as an example. The three devices will each obtain a quantization scale factor corresponding to the model function network E1 (that is, three quantization scale factors), and then the largest quantization scale factor will be selected from the three quantization scale factors as the target quantization scale factor corresponding to the model function network E1.

In this way, based on the embodiment, mixed bit quantization models are respectively deployed on a plurality of devices to the target quantization scale factor of the same model function network, ensuring that each device can execute tasks normally and improving the accuracy of the target quantization scale factor.

S402: Store the target bit quantization manner, the target quantization scale factor, and identification information corresponding to the model function network in a specified area in an associated manner.

In this embodiment of the present disclosure, after the target quantization scale factor is generated in the target bit quantization manner, the target bit quantization manner, the target quantization scale factor, and the identification information corresponding to the model function network (configured for uniquely identifying the model function network, and including but not limited to, a name, a number, and the like) may be stored in a specified area in an associated manner.

For example, continuing the foregoing example, Table 2 is an example table for associated storage.

TABLE 2

| Model | Target bit | |
|---|---|---|
| function | quantization | |
| network | manner | Target quantization scale factor |
| E1 | int2 | Combinations of Channel 1: {sal_1, sal_2} |
| | | . . . |
| | | Combinations of Channel 128: |
| | | {sa128_1, sa128_2} |
| E2 | int4 | Combinations of Channel 1: {sal_1, sal_2} |
| | | . . . |
| | | Combinations of Channel 64: |
| | | {sa64_1, sa64_2} |
| E3 | int8 | Channel 1: {sa1} |
| | | . . . |
| | | Channel 64: {sa64} |

S403: Acquire, upon determining that the model function network is at the inference phase, the target bit quantization manner and the target quantization scale factor from the specified area to perform quantization processing on the original model parameter.

In this embodiment of the present disclosure, when it is determined that the model function network is at the inference phase, the target bit quantization manner and the target quantization scale factor corresponding to the model function network may be acquired from the specified storage area, and quantization processing may be performed on the original model parameter corresponding to the model function network. In an embodiment, whether the model function network is an inference model, that is, whether it is at the inference phase, may be determined according to a file format of the model function network.

For a detailed description of S201 to S203 shown in FIG. 4, reference may be made to S201 to S203 shown in FIG. 2, and details are not described herein again.

In this embodiment of the present disclosure, the target bit quantization manner, the target quantization scale factor, and the identification information corresponding to the model function network are stored in an associated manner, which can be directly used during model inference, so that the efficiency of quantization processing is improved, and reliability of quantization processing is high, thereby further improving model performance.

A specific scenario of the embodiments of the present disclosure is described below in detail.

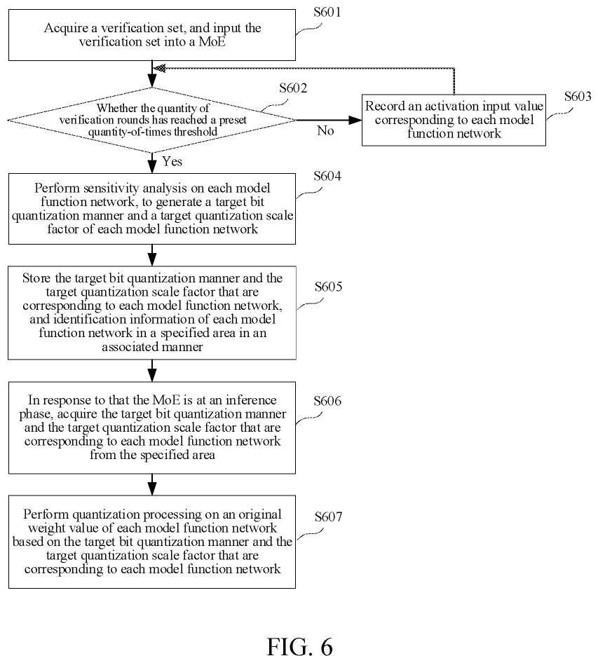

FIG. 6 is a flowchart of a quantization-based data processing method according to an embodiment of the present disclosure. As shown in FIG. 6, the quantization-based data processing method includes at least operations S601 to S607, which are described in detail as follows:

S601: Acquire a verification set, and input the verification set into a MoE.

In this embodiment of the present disclosure, the MoE is configured for, including but not limited to, text processing, video processing, speech processing, and the like. The verification set is a collection obtained by sampling a small portion of a dataset configured for model training, and is configured for being inputted into the model for calibration sampling, to obtain a quantization scale factor of each layer.

S602: Detect whether the quantity of verification rounds has reached a preset quantity-of-times threshold, if the quantity has not reached the preset quantity-of-times threshold, perform S603, and if the quantity has reached the preset quantity-of-times threshold, perform S604.

S603: Record an activation input value corresponding to each model function network, and return to S602.

S604: Perform sensitivity analysis on each model function network, to generate a target bit quantization manner and a target quantization scale factor of each model function network.

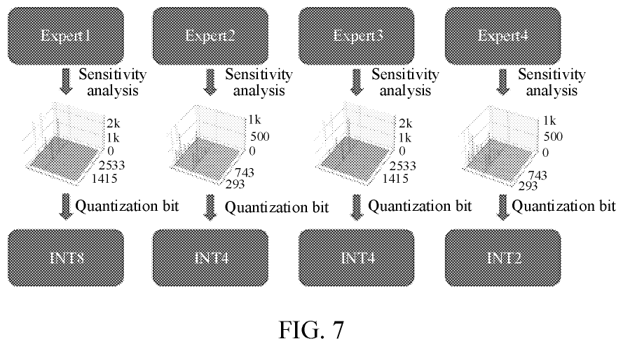

In this embodiment of the present disclosure, the sensitivity analysis may be achieved by calculating a cosine similarity as described above, to generate the target bit quantization manner of each model function network. For example, for generating the target bit quantization manner of each model function network, reference may be made to FIG. 7. As shown in FIG. 7, the MoE includes four expert networks (that is, function networks), which are Expert1, Expert2, Expert3, and Expert4 respectively. Sensitivity analysis is performed on Expert1 to obtain a target bit quantization manner INT8; sensitivity analysis is performed on Expert2 to obtain a target bit quantization manner INT4; sensitivity analysis is performed on Expert3 to obtain a target bit quantization manner INT4; and sensitivity analysis is performed on Expert4 to obtain a target bit quantization manner INT2.

For example, the generating a target quantization scale factor of each model function network may include: if a first model function network of which a quantization precision of a target bit quantization manner is greater than a preset precision threshold exists in the plurality of model function networks, generating a target quantization scale factor corresponding to each data channel in the first model function network; and if a second model function network of which a quantization precision of a target bit quantization manner is less than or equal to the preset precision threshold exists in the plurality of model function networks, grouping channel values of each data channel in the second model function network, and generating a target quantization scale factor corresponding to each combination. That is, when the quantization precision of the target bit quantization manner corresponding to the model function network is relatively high, the target quantization scale factor is calculated based on coarser-grained data channels; and when the quantization precision of the target bit quantization manner corresponding to the model function network is relatively low, the target quantization scale factor is calculated based on finer-grained combinations.

S605: Store the target bit quantization manner and the target quantization scale factor that are corresponding to each model function network, and identification information of each model function network in a specified area in an associated manner.

In this embodiment of the present disclosure, the target bit quantization manner and the target quantization scale factor that are corresponding to each model function network, and the identification information of each model function network may be stored in a vector form in a specified area locally or in the cloud through a storage interface (for example, torch.save).

S606: In response to that the MoE is at an inference phase, acquire the target bit quantization manner and the target quantization scale factor that are corresponding to each model function network from the specified area.

S607: Perform quantization processing on an original weight value of each model function network based on the target bit quantization manner and the target quantization scale factor that are corresponding to each model function network.

In this embodiment of the present disclosure, a mapping relationship table between preset bit quantization manners and computation kernels may be looked up to obtain a target computation kernel corresponding to each model function network, and then a corresponding target quantization scale factor is introduced in the computation process of each target computation kernel, to quantize the original weight value to a corresponding target quantization bit number, thereby realizing mixed bit quantization inference of the MoE, and obtaining the corresponding task processing results.

In an embodiment, when the MoE is applied to text processing application scenarios, the scenarios include, but not limited to:
(1) Text classification (such as email classification and news classification). In this case, the MoE may be a text classification model. Specifically, text to be classified is inputted into the text classification model. In the text classification model, a target bit quantization manner and a target quantization scale factor that are corresponding to each function network in the text classification model are obtained in the foregoing manner. Quantization processing is performed based on the target bit quantization manner and the target quantization scale factor that are corresponding to each function network, then text classification is performed based on the quantized data, and text classification information is outputted. The text classification model has good performance, thereby improving the accuracy, efficiency, and the like of text classification.
(2) Contextual understanding and automatic replies (such as automated customer service and chatting robot). In this case, the MoE may be a reply model. Specifically, text to be replied to is inputted into the reply model. In the reply model, a target bit quantization manner and a target quantization scale factor that are corresponding to each function network in the reply model are obtained in the foregoing manner. Quantization processing is performed based on the target bit quantization manner and the target quantization scale factor that are corresponding to each function network, then the user′ intention is understood based on the quantized data, and reply information is outputted. The reply model has good performance, thereby improving the accuracy, efficiency, and the like of contextual understanding and automatic replies.
(3) Multilingual text processing (such as text translation and language recognition). In this case, the MoE may be a multilingual processing model. Specifically, text to be processed is inputted into the multilingual processing model. In the multilingual processing model, a target bit quantization manner and a target quantization scale factor that are corresponding to each function network in the multilingual processing model are obtained in the foregoing manner. Quantization processing is performed based on the target bit quantization manner and the target quantization scale factor that are corresponding to each function network, then text parsing is performed based on the quantized data, and text parsing information is outputted. The multilingual processing model has good performance, thereby improving the accuracy, efficiency, and the like of multilingual text processing.

In an embodiment, when the MoE is applied to video processing application scenarios, the scenarios include, but not limited to:
(1) Video detection (such as recognizing different actions, scenes, and objects in a video). In this case, the MoE may be a video detection model. Specifically, a video to be detected is inputted into the video detection model. In the video detection model, a target bit quantization manner and a target quantization scale factor that are corresponding to each function network in the video detection model are obtained in the foregoing manner. Quantization processing is performed based on the target bit quantization manner and the target quantization scale factor that are corresponding to each function network, then video detection is performed based on the quantized data, and video detection information is outputted. The video detection model has good performance, thereby improving the accuracy, efficiency, and the like of video detection.
(2) Video compression and transmission (such as online video playback and video conferencing). In this case, the MoE may be a video transmission model. Specifically, a video to be transmitted is inputted into the video transmission model. In the video transmission model, a target bit quantization manner and a target quantization scale factor that are corresponding to each function network in the video transmission model are obtained in the foregoing manner. Quantization processing is performed based on the target bit quantization manner and the target quantization scale factor that are corresponding to each function network, and then video compression is performed based on the quantized data, achieving efficient video transmission and good playback experience. The video transmission model has good performance, thereby improving the accuracy, efficiency, and the like of video compression and transmission.
(3) Video effects and enhancements (such as film and television production, virtual reality, and augmented reality). In this case, the MoE may be a video processing model. Specifically, a video to be processed is inputted into the video processing model. In the video processing model, a target bit quantization manner and a target quantization scale factor that are corresponding to each function network in the video processing model are obtained in the foregoing manner. Quantization processing is performed based on the target bit quantization manner and the target quantization scale factor that are corresponding to each function network, and then effect and enhancement processing is performed based on the quantized data, achieving efficient video rendering. The video processing model has good performance, thereby improving the accuracy, efficiency, and the like of video effects and enhancements.

In an embodiment, when the MoE is applied to speech processing application scenarios, the scenarios include, but not limited to:
(1) Speech recognition and transcription (such as speech assistant, speech search, and subtitle generation). in this case, the MoE may be a speech recognition model. Specifically, a speech to be recognized is inputted into the speech recognition model. In the speech recognition model, a target bit quantization manner and a target quantization scale factor that are corresponding to each function network in the speech recognition model are obtained in the foregoing manner. Quantization processing is performed based on the target bit quantization manner and the target quantization scale factor that are corresponding to each function network, then speech recognition and transcription is performed based on the quantized data, and speech recognition information is outputted. The speech recognition model has good performance, thereby improving the accuracy, efficiency, and the like of speech recognition and transcription.
(2) Speech activity detection and keyword recognition (such as wake word detection and speech control). In this case, the MoE may be a speech detection model. Specifically, a speech to be detected is inputted into the speech detection model. In the speech detection model, a target bit quantization manner and a target quantization scale factor that are corresponding to each function network in the speech detection model are obtained in the foregoing manner. Quantization processing is performed based on the target bit quantization manner and the target quantization scale factor that are corresponding to each function network, then speech activity detection and keyword recognition are performed based on the quantized data, and speech detection information is outputted. The speech detection model has good performance, thereby improving the accuracy, efficiency, and the like of speech activity detection and keyword recognition.
(3) Speech quality enhancement and noise reduction (such as teleconference, voice calls, and recording applications). In this case, the MoE may be a speech enhancement model. Specifically, a speech to be enhanced is inputted into the speech enhancement model. In the speech enhancement model, a target bit quantization manner and a target quantization scale factor that are corresponding to each function network in the speech enhancement model are obtained in the foregoing manner. Quantization processing is performed based on the target bit quantization manner and the target quantization scale factor that are corresponding to each function network, then speech quality enhancement and noise reduction are performed based on the quantized data, and speech enhancement information is outputted. The speech enhancement model has good performance, thereby improving the accuracy, efficiency, and the like of speech quality enhancement and noise reduction.

For a detailed description of determining the target bit quantization manner and the target quantization scale factor that are corresponding to each function network in the corresponding model, and performing quantization processing based on the target bit quantization manner and the target quantization scale factor that are corresponding to each function network involved in the foregoing application scenarios, reference may be made to the foregoing embodiments, and details are not described herein again.

In this embodiment of the present disclosure, models of different sizes, 7B-MoE and 70B-MoE, are used for tests on a ptb-en verification set. The test results are shown in Table 3.

TABLE 3

| Inference | | | Mixed bit quantization |
|---|---|---|---|
| precision | bf16 | int8 | (int2 − int4 + int8) |
| 7B-MOE | 12.209 | 12.323 | 12.350 |
| 70B-MOE | 8.858 | 8.903 | 8.925 |

As shown in Table 3, the obtained values are all perplexity (PPL) values. A smaller PPL value indicates a smaller loss. For 7B-MoE, the PPL values arranged in an ascending order are 12.209<12.323<12.350; and for 70B-MoE, the PPL values arranged in an ascending order are 8.858<8.903<8.925, where mixed bit quantization is not much different from bf16 and int8. As can be seen, the quantization precision in this embodiment of the present disclosure is close to lossless, and the model performance is good.

Some experiments were completed using a Mixtral-7×8B model on an 8×A800 GPU server, compared with BF16 quantization processing, the disclosed method with s mixed bit quantization scheme saved approximately two-thirds of the GPU memory, and the maximum throughput (i.e., maximum batch size) on the GPU was doubled.

In deploying MoE-based text-to-text large language models, using the disclosed automatic mixed bit quantization method can achieve text-generation quality that is essentially lossless compared with BF16, while saving at least one-half to two-thirds of GPU resources, thereby reducing the overall cost of the large-model deployment.

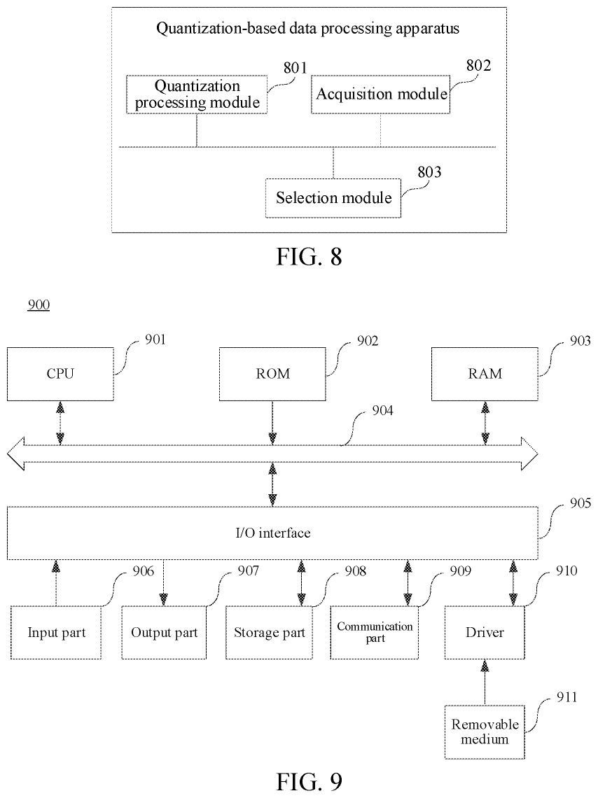

FIG. 8 is a block diagram of a quantization-based data processing apparatus according to an embodiment of the present disclosure. As shown in FIG. 8, the apparatus includes:
a quantization processing module 801, configured to respectively perform quantization processing on an original model parameter corresponding to a model function network in a plurality of bit quantization manners, to obtain a plurality of quantized model parameters each corresponding to one of the plurality of bit quantization manners;
an acquisition module 802, configured to acquire a first output result of the model function network under the original model parameter, and acquire a plurality of second output results of the model function network under the plurality of quantized model parameters; and
a selection module 803, configured to select a target bit quantization manner from the plurality of bit quantization manners based on the first output result and the plurality of second output results, the target bit quantization manner being configured to perform quantization processing on the original model parameter during an inference phase corresponding to the model function network.

In an embodiment of the present disclosure, based on the foregoing solution, the selection module 803 is specifically configured to:
calculate a difference value between the first output result and each second output result; and
select a bit quantization manner corresponding to a smallest difference value from the plurality of bit quantization manners, and use the selected bit quantization manner as the target bit quantization manner.

In an embodiment of the present disclosure, based on the foregoing solution, the selection module 803 is further specifically configured to:
for each second output result, perform a difference operation on the first output result and the second output result to obtain a difference, and raise the obtained difference to a specified power to obtain a difference value between the first output result and the second output result.

In an embodiment of the present disclosure, based on the foregoing solution, the selection module 803 is further specifically configured to:
for each second output result, calculate a signal power value based on the second output result, calculate a noise power value based on the first output result and the second output result, calculate a signal-to-noise ratio based on the signal power value and the noise power value, and calculate a difference value between the first output result the second output result based on the signal-to-noise ratio.

In an embodiment of the present disclosure, based on the foregoing solution, the original model parameter includes an original weight value, and the quantized model parameter includes a quantized weight value; and the acquisition module 802 is specifically configured to:
acquire an activation input value of the model function network; and
perform a product operation on the activation input value and the original weight value, to obtain the first output result of the model function network, and perform a product operation on the activation input value and each quantized weight value, to obtain the plurality of second output results of the model function network.

In an embodiment of the present disclosure, based on the foregoing solution, the model function network corresponds to a plurality of data channels, and each data channel corresponds to channel values; and the acquisition module 802 is further specifically configured to:
in response to that outlier channel values exist, use a data channel corresponding to a largest outlier channel value as a target data channel, use channel values corresponding to the target data channel as the activation input value of the model function network, and acquire an original weight value and quantized weight values that are corresponding to the target data channel; and
perform a product operation on the channel values and the original weight value that are corresponding to the target data channel, to obtain the first output result of the model function network, and perform a product operation on the channel values and each quantized weight value that are corresponding to the target data channel, to obtain the plurality of second output results of the model function network.

In an embodiment of the present disclosure, based on the foregoing solution, the acquisition module 802 is further specifically configured to:
calculate a similarity between the target data channel and an adjacent data channel corresponding to the target data channel;
reduce outlier channel values in the target data channel based on the similarity, to obtain target channel values; and
use the target channel values and channel values in the target data channel other than the outlier channel values as the activation input value of the model function network.

In an embodiment of the present disclosure, based on the foregoing solution, the acquisition module 802 is further specifically configured to:
perform a distance operation based on the channel values of the target data channel and channel values of the adjacent data channel corresponding to the target data channel to obtain a distance value, the distance value being greater than 0 and less than 1, and use the distance value as the similarity between the target data channel and the adjacent data channel; and
perform a product operation on the distance value and the outlier channel values in the target data channel, to obtain the target channel values.

In an embodiment of the present disclosure, based on the foregoing solution, the apparatus further includes:
a generation module, configured to generate a target quantization scale factor based on the target bit quantization manner;
a storage module, configured to store the target bit quantization manner, the target quantization scale factor, and identification information corresponding to the model function network in a specified area in an associated manner; and
an inference module, configured to acquire, if it is detected to be at the inference phase of the model function network, the target bit quantization manner and the target quantization scale factor from the specified area to perform quantization processing on the original model parameter.

In an embodiment of the present disclosure, based on the foregoing solution, there are a plurality of model function networks; and the generation module is specifically configured to:
if a first model function network of which a quantization precision of a target bit quantization manner is greater than a preset precision threshold exists in the plurality of model function networks, generate a target quantization scale factor corresponding to each data channel in the first model function network; and
if a second model function network of which a quantization precision of a target bit quantization manner is less than or equal to the preset precision threshold exists in the plurality of model function networks, group channel values of each data channel in the second model function network to obtain a plurality of combinations, and generate a target quantization scale factor corresponding to each combination of the plurality of combinations.

In an embodiment of the present disclosure, based on the foregoing solution, the generation module is further specifically configured to:
acquire the target bit quantization manner corresponding to the first model function network; and
for each data channel in the first model function network, perform an operation based on the acquired target bit quantization manner, an activation input value corresponding to the data channel, and each quantization scale factor, to obtain an operation result corresponding to the each quantization scale factor, and use a quantization scale factor corresponding to an operation result with a largest absolute value in a plurality of operation results as a target quantization scale factor of the data channel.

In an embodiment of the present disclosure, based on the foregoing solution, the generation module is further specifically configured to:
traverse a first quantization scale factor in a first scale factor list, and perform an operation based on the acquired target bit quantization manner, the activation input value corresponding to the data channel, and the traversed quantization scale factor, to obtain an operation result corresponding to the traversed quantization scale factor; and
update the activation input value corresponding to the data channel, traverse a next adjacent quantization scale factor of the first quantization scale factor, perform an operation based on the acquired target bit quantization manner, the updated activation input value, and the traversed quantization scale factor to obtain an operation result corresponding to the traversed quantization scale factor, and repeat the process until the first scale factor list is completely traversed, to obtain an operation result corresponding to each quantization scale factor in the first scale factor list.

In an embodiment of the present disclosure, based on the foregoing solution, the generation module is further specifically configured to:
acquire the target bit quantization manner corresponding to the second model function network; and
for each combination corresponding to each data channel in the second model function network, perform an operation based on the acquired target bit quantization manner, an activation input value corresponding to the combination, and each quantization scale factor, to obtain an operation result corresponding to the each quantization scale factor, and use a quantization scale factor corresponding to an operation result with a largest absolute value in a plurality of operation results as a target quantization scale factor of the combination.

In an embodiment of the present disclosure, based on the foregoing solution, the generation module is further specifically configured to:
traverse a first quantization scale factor in a second scale factor list, and perform an operation based on the acquired target bit quantization manner, the activation input value corresponding to the combination, and the traversed quantization scale factor, to obtain an operation result corresponding to the traversed quantization scale factor; and
update the activation input value corresponding to the combination, traverse a next adjacent quantization scale factor of the first quantization scale factor, perform an operation based on the acquired target bit quantization manner, the updated activation input value, and the traversed quantization scale factor to obtain an operation result corresponding to the traversed quantization scale factor, and repeat the process until the second scale factor list is completely traversed, to obtain an operation result corresponding to each quantization scale factor in the second scale factor list.

In an embodiment of the present disclosure, based on the foregoing solution, the generation module is further specifically configured to:
respectively obtain quantization scale factors corresponding to the target bit quantization manner by using a plurality of devices on which a mixed bit quantization model is deployed; and
select a largest quantization scale factor from the plurality of quantization scale factors as the target quantization scale factor.

The apparatuses provided in the foregoing embodiments and the methods provided in the foregoing embodiments belong to the same idea. Specific operation manners of the modules and units have been described in detail in the method embodiments.

An embodiment of the present disclosure further provides an electronic device, including: one or more processors; and a memory, configured to store one or more computer programs, the one or more computer programs, when executed by the one or more processors, causing the electronic device to implement the quantization-based data processing method described in the foregoing embodiments.

FIG. 9 is a schematic structural diagram of a computer system adapted to implement an electronic device (for example, the terminal device or server shown in FIG. 1) according to an embodiment of the present disclosure.

The computer system 900 of the electronic device shown in FIG. 9 is merely an example, and does not constitute any limitation on functions and use ranges of the embodiments of the present disclosure.

As shown in FIG. 9, the computer system 900 includes a central processing unit (CPU) 901, which may perform various suitable actions and processing based on a computer program stored in a read-only memory (ROM) 902 or a computer program loaded from a storage part 908 into a random access memory (RAM) 903, for example, perform the method in the foregoing embodiments. The RAM 903 further stores various computer programs and data required for system operations. The CPU 901, the ROM 902, and the RAM 903 are connected to each other through a bus 904. An input/output (I/O) interface 905 is also connected to the bus 904.

The following components are connected to the I/O interface 905: an input part 906 including a keyboard, a mouse, or the like, an output part 907 including a cathode ray tube (CRT), a liquid crystal display (LCD), a speaker, or the like, a storage part 908 including a hard disk, or the like, and a communication part 909 including a network interface card such as a local area network (LAN) card or a modem. The communication part 909 performs communication processing by using a network such as the Internet. A driver 910 is also connected to the I/O interface 905 as required. A removable medium 911, such as a magnetic disk, an optical disc, a magneto-optical disk, or a semiconductor memory, is installed on the drive 910 as required, so that a computer program read from the removable medium is installed into the storage part 908 as required.

Particularly, according to an embodiment of the present disclosure, the processes described above by referring to the flowcharts may be implemented as computer programs. For example, an embodiment of the present disclosure includes a computer program product, the computer program product includes a computer program carried on a computer-readable medium, and the computer program includes computer instructions used for performing the methods shown in the flowcharts. In such an embodiment, the computer program may be downloaded and installed from a network through the communication part 909, and/or installed from the removable medium 911. When the computer program is executed by the CPU 901, the various functions defined in the system of this embodiment of the present disclosure are executed.

The computer-readable medium shown in the embodiments of the present disclosure may be a computer-readable signal medium or a computer-readable storage medium or any combination thereof. The computer-readable medium may be, for example, an electric, magnetic, optical, electromagnetic, infrared, or semiconductor system, apparatus, or device, or any combination thereof. A more specific example of the computer-readable medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any appropriate combination thereof. In this embodiment of the present disclosure, the computer-readable medium may be any tangible medium including or storing a computer program, and the computer program may be used by or used in combination with an instruction execution system, apparatus, or device. In this embodiment of the present disclosure, a computer-readable signal medium may include a data signal being in a baseband or propagated as a part of a carrier wave, the data signal carrying computer-readable computer program. The propagated data signal may be in a plurality of forms, including but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a computer program that is used by or used in combination with an instruction execution system, apparatus, or device. The computer program included in the computer-readable medium may be transmitted by using any suitable medium, including but not limited to: a wireless medium, a wire, or the like, or any suitable combination thereof.

The flowcharts and block diagrams in the accompanying drawings illustrate possible system architectures, functions and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and computer instructions.

A related unit described in the embodiments of the present disclosure may be implemented in a software manner, or may be implemented in a hardware manner, and the unit described can also be set in a processor. Names of the units do not constitute a limitation on the units in a specific case.

An embodiment of the present disclosure further provides a computer-readable medium, having a computer program stored therein, the computer program, when executed by a processor, implementing the foregoing quantization-based data processing method. The computer-readable medium may be included in the electronic device described in the foregoing embodiments, or may exist alone and is not disposed in the electronic device.

An embodiment of the present disclosure further provides a computer program product or a computer program. The computer program product or the computer program includes computer instructions, the computer instructions being stored in a computer-readable medium. A processor of an electronic device reads the computer instructions from the computer-readable medium and executes the computer instructions to cause the electronic device to perform the quantization-based data processing method provided in the foregoing embodiments.

The foregoing descriptions are merely exemplary embodiments of the present disclosure, and are not intended to limit the implementations of the present disclosure. A person of ordinary skill in the art may conveniently make corresponding variations or modifications according to the main idea and spirit of the embodiments of the present disclosure. Therefore, the protection scope of the present disclosure shall be subject to the protection scope of the claims.

What is claimed is:

1. A quantization-based data processing method, comprising:
respectively performing quantization processing on an original model parameter corresponding to a model function network in a plurality of bit quantization manners, to obtain a plurality of quantized model parameters each corresponding to one of the plurality of bit quantization manners;
acquiring a first output result of the model function network under the original model parameter, and acquiring a plurality of second output results of the model function network under the plurality of quantized model parameters;
selecting a target bit quantization manner from the plurality of bit quantization manners based on the first output result and the plurality of second output results;
generating a target quantization scale factor based on the target bit quantization manner; and
performing, based on the target bit quantization manner and the target quantization scale factor, quantization processing on the original model parameter during an inference phase of the model function network.

2. The method according to claim 1, wherein the selecting a target bit quantization manner from the plurality of bit quantization manners based on the first output result and the plurality of second output results comprises:
calculating a difference value between the first output result and each second output result; and
selecting a bit quantization manner corresponding to a smallest difference value from the plurality of bit quantization manners, and using the selected bit quantization manner as the target bit quantization manner.

3. The method according to claim 2, wherein the calculating a difference value between the first output result and each second output result comprises:
for each second output result, performing a difference operation on the first output result and the second output result to obtain a difference, and raising the obtained difference to a specified power to obtain a difference value between the first output result and the second output result.

4. The method according to claim 2, wherein the calculating a difference value between the first output result and each second output result comprises:
for each second output result, calculating a signal power value based on the second output result, calculating a noise power value based on the first output result and the second output result, calculating a signal-to-noise ratio based on the signal power value and the noise power value, and calculating a difference value between the first output result the second output result based on the signal-to-noise ratio.

5. The method according to claim 1, wherein the original model parameter comprises an original weight value, and the quantized model parameter comprises a quantized weight value; and the acquiring a first output result of the model function network under the original model parameter, and acquiring a plurality of second output results of the model function network under the plurality of quantized model parameters comprises:
acquiring an activation input value of the model function network; and
performing a product operation on the activation input value and the original weight value, to obtain the first output result of the model function network, and performing a product operation on the activation input value and each quantized weight value, to obtain the plurality of second output results of the model function network.

6. The method according to claim 5, wherein the model function network corresponds to a plurality of data channels, and each data channel corresponds to channel values; the acquiring an activation input value of the model function network comprises:
detecting whether an outlier channel value exists in each of the plurality of data channels; and
in response to that outlier channel values exist, comparing all detected outlier channel values, using a data channel corresponding to a largest outlier channel value as a target data channel, using channel values corresponding to the target data channel as the activation input value of the model function network, and acquiring an original weight value and quantized weight values that are corresponding to the target data channel; and
the performing a product operation on the activation input value and the original weight value, to obtain the first output result of the model function network, and performing a product operation on the activation input value and each quantized weight value, to obtain the plurality of second output results of the model function network comprises:
performing a product operation on the channel values and the original weight value that are corresponding to the target data channel, to obtain the first output result of the model function network, and performing a product operation on the channel values and each quantized weight value that are corresponding to the target data channel, to obtain the plurality of second output results of the model function network.

7. The method according to claim 6, wherein the using channel values corresponding to the target data channel as the activation input value of the model function network comprises:
calculating a similarity between the target data channel and an adjacent data channel corresponding to the target data channel;
reducing outlier channel values in the target data channel based on the similarity, to obtain target channel values; and
using the target channel values and channel values in the target data channel other than the outlier channel values as the activation input value of the model function network.

8. The method according to claim 7, wherein the calculating a similarity between the target data channel and an adjacent data channel corresponding to the target data channel comprises:
performing a distance operation based on the channel values of the target data channel and channel values of the adjacent data channel corresponding to the target data channel to obtain a distance value, the distance value being greater than 0 and less than 1, and using the distance value as the similarity between the target data channel and the adjacent data channel; and
the reducing outlier channel values in the target data channel based on the similarity, to obtain target channel values comprises:
performing a product operation on the distance value and the outlier channel values in the target data channel, to obtain the target channel values.

9. The method according to claim 1, wherein performing quantization processing on the original model parameter comprises:
storing the target bit quantization manner, the target quantization scale factor, and identification information corresponding to the model function network in a specified area in an associated manner; and
acquiring, in response to detecting the inference phase of the model function network, the target bit quantization manner and the target quantization scale factor from the specified area to perform quantization processing on the original model parameter.

10. The method according to claim 1, wherein the generating the target quantization scale factor based on the target bit quantization manner comprises:
in response to a quantization precision of the target bit quantization manner being greater than a preset precision threshold, generating the target quantization scale factor corresponding to each data channel in the model function network; and
in response to the quantization precision of the target bit quantization manner being less than or equal to the preset precision threshold, grouping channel values of each data channel in the model function network to obtain a plurality of combinations, and generating the target quantization scale factor corresponding to each combination.

11. The method according to claim 10, wherein the generating a target quantization scale factor corresponding to each data channel in the model function network comprises:
for each data channel in the first model function network, performing a plurality of operations based on the target bit quantization manner, an activation input value corresponding to the data channel, and a plurality of quantization scale factors, to obtain a plurality of operation results each corresponding to one of the plurality of the quantization scale factors; and
using a quantization scale factor corresponding to an operation result with a largest absolute value in the plurality of operation results as a target quantization scale factor of the data channel.

12. The method according to claim 11, wherein the performing a plurality of operations based on the target bit quantization manner, an activation input value corresponding to the data channel, and a plurality of quantization scale factors, to obtain a plurality of operation results each corresponding to one of the plurality of the quantization scale factors comprises:
traversing a first quantization scale factor in a first scale factor list, and performing an operation based on the target bit quantization manner, the activation input value corresponding to the data channel, and the traversed quantization scale factor, to obtain an operation result corresponding to the traversed quantization scale factor; and
repeating the following steps until the first scale factor list is completely traversed to obtain an operation result corresponding to each quantization scale factor in the first scale factor list:
updating the activation input value corresponding to the data channel, and
performing an operation based on the target bit quantization manner, the updated activation input value, and a currently-traversed quantization scale factor to obtain an operation result corresponding to the currently-traversed quantization scale factor.

13. The method according to claim 10, wherein the generating a target quantization scale factor corresponding to each combination comprises:
for each combination corresponding to each data channel in the model function network, performing an operation based on the target bit quantization manner, an activation input value corresponding to the combination, and a plurality of quantization scale factors, to obtain a plurality of operation results each corresponding to one of the plurality of the quantization scale factors; and
using a quantization scale factor corresponding to an operation result with a largest absolute value in the plurality of operation results as a target quantization scale factor of the combination.

14. The method according to claim 13, wherein the performing a plurality of operation based on the target bit quantization manner, an activation input value corresponding to the combination, and a plurality of quantization scale factors, to obtain a plurality of operation results each corresponding to one of the plurality of the quantization scale factors comprises:
traversing a first quantization scale factor in a second scale factor list, and performing an operation based on the target bit quantization manner, the activation input value corresponding to the combination, and the traversed quantization scale factor, to obtain an operation result corresponding to the traversed quantization scale factor; and
repeating the following steps until the second scale factor list is completely traversed, to obtain an operation result corresponding to each quantization scale factor in the second scale factor list
updating the activation input value corresponding to the combination, and
performing an operation based on the target bit quantization manner, the updated activation input value, and a currently-traversed quantization scale factor to obtain an operation result corresponding to the currently-traversed quantization scale factor.

15. The method according to claim 1, wherein the generating a target quantization scale factor based on the target bit quantization manner comprises:
respectively obtaining quantization scale factors corresponding to the target bit quantization manner by using a plurality of devices on which a mixed bit quantization model is deployed; and
selecting a largest quantization scale factor from the plurality of quantization scale factors as the target quantization scale factor.

16. An electronic device, comprising:
one or more processors; and
a memory, configured to store one or more programs, the one or more programs, when executed by the one or more processors, causing the one or more processors to implement:
respectively performing quantization processing on an original model parameter corresponding to a model function network in a plurality of bit quantization manners, to obtain a plurality of quantized model parameters each corresponding to one of the plurality of bit quantization manners;
acquiring a first output result of the model function network under the original model parameter, and acquiring a plurality of second output results of the model function network under the plurality of quantized model parameters;
selecting a target bit quantization manner from the plurality of bit quantization manners based on the first output result and the plurality of second output results;
generating a target quantization scale factor based on the target bit quantization manner; and
performing, based on the target bit quantization manner and the target quantization scale factor, quantization processing on the original model parameter during an inference phase of the model function network.

17. The electronic device according to claim 16, wherein the generating the target quantization scale factor based on the target bit quantization manner comprises:
in response to a quantization precision of the target bit quantization manner being greater than a preset precision threshold, generating the target quantization scale factor corresponding to each data channel in the model function network; and
in response to the quantization precision of the target bit quantization manner being less than or equal to the preset precision threshold, grouping channel values of each data channel in the model function network to obtain a plurality of combinations, and generating the target quantization scale factor corresponding to each combination.

18. The electronic device according to claim 17, wherein the generating a target quantization scale factor corresponding to each data channel in the model function network comprises:
for each data channel in the first model function network, performing a plurality of operations based on the target bit quantization manner, an activation input value corresponding to the data channel, and a plurality of quantization scale factors, to obtain a plurality of operation results each corresponding to one of the plurality of the quantization scale factors; and
using a quantization scale factor corresponding to an operation result with a largest absolute value in the plurality of operation results as a target quantization scale factor of the data channel.

19. The electronic device according to claim 17, wherein the generating a target quantization scale factor corresponding to each combination comprises:
for each combination corresponding to each data channel in the model function network, performing an operation based on the target bit quantization manner, an activation input value corresponding to the combination, and a plurality of quantization scale factors, to obtain a plurality of operation results each corresponding to one of the plurality of the quantization scale factors; and
using a quantization scale factor corresponding to an operation result with a largest absolute value in the plurality of operation results as a target quantization scale factor of the combination.

20. A non-transitory computer-readable medium, having a computer program stored therein, the computer program, when executed by a processor, causing the processor to implement:
respectively performing quantization processing on an original model parameter corresponding to a model function network in a plurality of bit quantization manners, to obtain a plurality of quantized model parameters each corresponding to one of the plurality of bit quantization manners;
acquiring a first output result of the model function network under the original model parameter, and acquiring a plurality of second output results of the model function network under the plurality of quantized model parameters;
selecting a target bit quantization manner from the plurality of bit quantization manners based on the first output result and the plurality of second output results;
generating a target quantization scale factor based on the target bit quantization manner; and
performing, based on the target bit quantization manner and the target quantization scale factor, quantization processing on the original model parameter during an inference phase of the model function network.
